(19) United States
(12) Patent Application Publication
(10) Pub. No.: US 2008/0277906 A1
(43) Pub. Date: Nov. 13, 2008

(54) Laundry cart adapted for multiple configurations

(75) Inventors: Robert W. Dunne, North Kingsville, OH (US); Waltor Brent Wilson, Jeffersonville, IN (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Meese, Inc., Saddle Brook, NJ (US)

(21) Appl. No.: 11/803,068

(22) Filed: May 11, 2007

(51) Int. Cl. B62B 3/02; B62B 3/00

(52) U.S. Cl. 280/659; 280/79.2

(57) ABSTRACT

A laundry cart adapted for multiple configurations includes a body defining an end opening at a top of the body and a notch opening in a front wall. The body is adapted for alternative receipt of a lid covering the end opening or a removable extension vertically extending a cart interior. The depicted body includes a peripheral ledge and a raised lip at the top. The front wall includes a ledge and recessed surface for receiving a door covering the notch opening. The lid and door may engage each other to hold the door in a closed position. The cart may include attachment mechanisms for releasably attaching the removable extension to the body and door latches for holding the door in a closed position. The cart may include a hanger bar for suspending laundry in the interior.

### FIELD OF THE INVENTION

The present invention relates generally to laundry carts and more particularly to a laundry cart adapted for multiple configurations.

### BACKGROUND OF THE INVENTION

Known carts and hampers for laundry include a body having walls defining an interior and having an end opening defined at a top of the body for placing laundry into, or removing laundry from, the cart interior. It is known to include a lid for covering the end opening of the body. It is also known to provide a door in one of the walls of the cart or hamper for access to the interior.

### SUMMARY OF THE INVENTION

According to the present invention, there is provided a laundry cart adapted for multiple configurations. The laundry cart includes a body having an interior and an end opening at a top of the body. The body includes a front wall, first and second side walls and a rear wall. The front wall includes a notch opening adjacent the top of the body communicating with the end opening.

The body is adapted adjacent the top of the body to alternatively receive a lid for covering the end opening or a removable extension for vertically extending the interior of the cart. According to one embodiment, the body includes a peripheral horizontal ledge located at the top of the body and a raised lip located inwardly of the horizontal ledge.

The front wall of the body is adapted to receive a door to cover the notch opening in the front wall. According to one embodiment, the front wall includes a ledge and a recessed surface extending along an edge of the notch opening.

According to one embodiment, the cart includes a lid covering the end opening. The cart may include hinges securing the lid to the body for rotation of the lid with respect to the body between opened and closed positions. Alternatively, the lid may be segmented having first and second segments that are rotatable with respect to each other.

According to one embodiment, the cart includes a removable extension received by the body for vertically extending the interior of the cart. The removable extension includes a rear wall, first and second side walls and at least a partial front wall. The cart may include at least one attachment mechanism having first and second parts respectively secured to the removable extension and the body. The first and second parts of the attachment mechanism are adapted for engagement with each other to provide releasable attachment between the extension and the body. The cart may also include a door covering the notch opening in the front wall of the body and at least one latch mechanism for holding the door in a closed position with respect to the body.

According to one embodiment, the cart includes at least one elongated hanger bar for suspending laundry within the interior of the cart. The hanger bar is supported at each of opposite ends by a side wall of the cart.

According to one aspect of the invention, a cart includes a body defining an interior, a lid covering an end opening of the body and a door covering a notch opening in a front wall of the body. The door and the lid are adapted to engage each other so as to hold the door in a closed position with respect to the body. According to one embodiment, the door includes a latch member at an end of the door adapted for receipt in a slot opening defined by the lid.

### BRIEF DESCRIPTION OF THE DRAWINGS

For the purpose of illustrating the invention, the drawings show a form of the invention that is presently preferred. However, it should be understood that this invention is not limited to the precise arrangements and instrumentalities shown in the drawings.

FIG. 1 is a perspective view of a laundry cart according to an exemplary embodiment of the invention.

FIG. 2 is a perspective view of a laundry cart according to a second exemplary embodiment including a hinged lid and a front door, the lid and door shown in closed positions with respect to the body of the cart.

FIG. 3 is a perspective view of the laundry cart of FIG. 2, the lid and door of the cart shown in opened positions with respect to the body.

FIG. 4 is a perspective view of a laundry cart according to a third exemplary embodiment including a split lid and a front door, the lid and door shown in closed positions with respect to the body of the cart.

FIG. 5 is a perspective view of the laundry cart of FIG. 4, the lid and door of the cart shown in opened positions with respect to the body.

FIG. 6 is a perspective view of a laundry cart according to a fourth exemplary embodiment of the invention including a removable extension received on the body of the cart.

FIG. 7 is a perspective view of a laundry cart according to a fifth exemplary embodiment of the invention including hanger bars.

FIG. 8 is an enlarged perspective view of a portion of the cart of FIG. 6 showing an attachment mechanism releasably securing the removable extension to the body and a door latch mechanism securing the door to the cart body in the closed position for the door.

### DESCRIPTION OF THE INVENTION

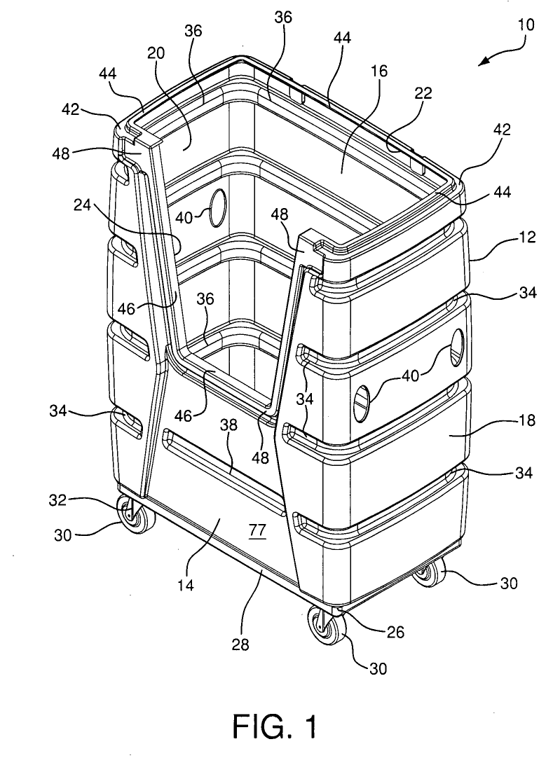

Referring to the drawings, where like numerals identify like elements, there is illustrated in FIG. 1 a laundry cart 10 according to the present invention. The laundry cart 10 includes a body 12 defining an interior for receiving laundry (e.g., clothes, towels, linens, etc.). The body 12 is generally rectangular in configuration including a front wall 14, an opposite rear wall 16, and a pair of side walls 18, 20.

The body 12 defines an opening 22 at a top end of the body 12 to facilitate placement of laundry into the interior of the body 12 and removal of laundry from the interior. To further facilitate placement and removal of laundry, the front wall 14 of the body 12 defines a notch opening 24 adjacent the end opening 22 such that the notch opening 24 and end opening 22 are contiguous with each other.

The cart 10 includes a wheeled base 26 supporting the body 12 of the cart 10 to facilitate movement of the cart 10 along an underlying support surface. The base 26 includes a plate 28 located adjacent a lower end of the cart body 12 and four wheels 30 each located adjacent a corner of the plate 28. The wheels 30 are secured to a lower surface of the plate 28 by brackets 32.

Each of the body walls 14, 16, 18, 20 is formed so as to define horizontally-extending indentations 34 on an outer surface of the wall and corresponding projections 36 on an inner surface. As should be understood, the forming of the walls 14, 16, 18, 20 in this manner serves to strengthen the walls (e.g., increase stiffness against deflection to promote robustness). As shown, the indentations 34 and projections 36 on each wall connect with those on adjacent walls such that elongated formations extend around the cart 10 starting at one side of the front wall 14 and ending at the opposite side of the front wall 14. The front wall 14 is also formed so as to define an indentation 38 (and corresponding projection) in an intermediate portion of the front wall 14 beneath the notch opening 24 to strengthen this portion of the front wall 14.

The body 12 of cart 10 includes a pair of openings 40 in each of the side walls 18, 20. The openings 40, which are located in an upper portion of the side walls, provides for passage of air through the walls 18, 20 to ventilate the interior of the body 12.

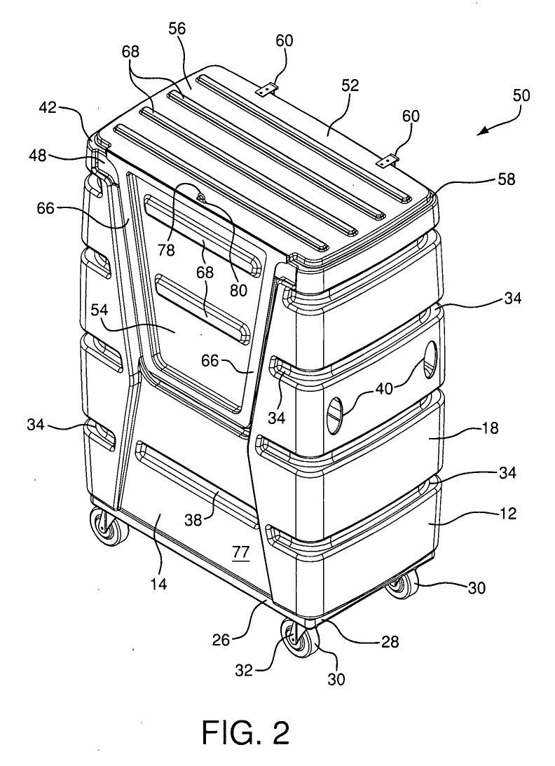

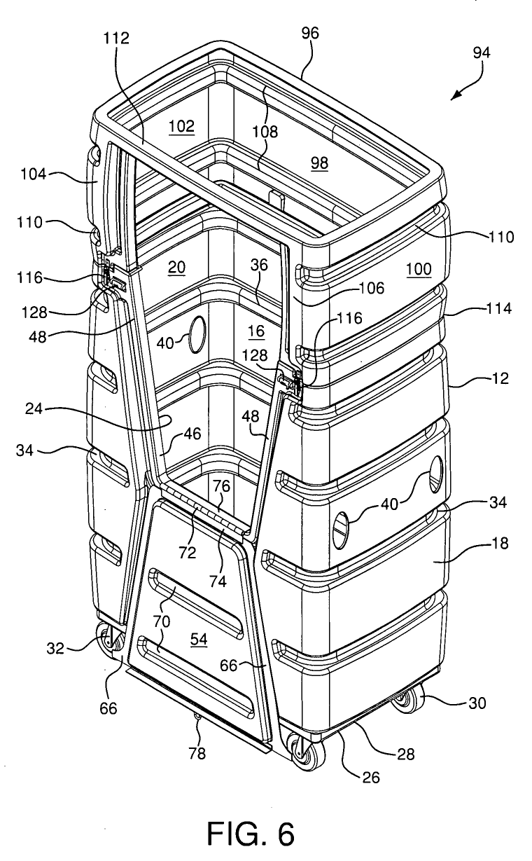

As described below in greater detail for FIGS. 2 through 8, the body 12 is adapted adjacent the top of the body 12 for alternatively receiving a lid (see FIGS. 2 through 5) for covering the end opening 22 or an extension (see FIGS. 6 through 8) for vertically extending the interior of the cart. As shown in FIG. 1, each of the side walls 18, 20 and rear wall 16 of the depicted cart body 12 is formed so as to define a substantially horizontal ledge 42 extending about a periphery of the cart 10 along the rear and side walls 16, 18, 20. A raised inner lip 44, having a substantially L-shaped cross-section extends along the rear and side walls 16, 18, 20 along an inward edge of the horizontal ledge 42. As described below for FIGS. 2 through 5, the horizontal ledge 42 and raised lip 44 of the cart body 12 are adapted to alternatively receive a lid or an extension. It is not a requirement, however, that the cart body 12 include the depicted ledge 42 and lip 44. Other alternative arrangements could be used.

As shown in FIG. 1, the front wall 14 of the body 12 of cart 10 is formed adjacent the notch opening 24 to turn inwardly with respect to the cart interior so as to define a ledge 46 that extends along the edges of the notch opening 24. The front wall 14 is also formed such that a recessed surface 48 is defined immediately adjacent to the ledge 46. As described below for FIGS. 2 through 7, the ledge 46 and recessed surface 48 of the front wall 14 are adapted to receive a door for closing the notch opening 24. Although the cart 10 shown in FIG. 1 is adapted for receiving a door and a lid to enclose the cart interior, or a removable extension for vertically extending the interior as described below, it should be understood that the cart 10 is adapted for use as shown in FIG. 1 to receive and transport laundry.

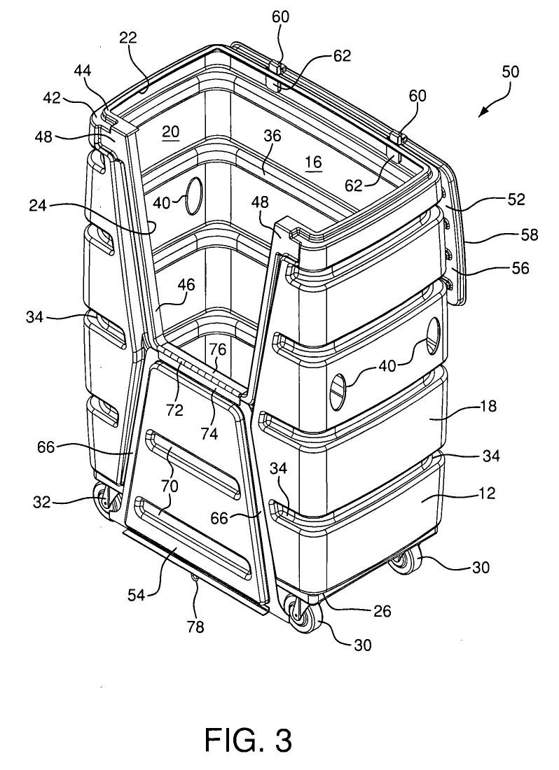

Referring to FIGS. 2 and 3, there is shown a cart 50 according to a second exemplary embodiment of the invention. Like cart 10, the cart 50 includes a body 12 having walls 14, 16, 18, 20 and a wheeled base 26. The cart 50 includes a lid 52 covering the end opening 22 at the top of the cart body 12, and a door 54 covering the notch opening 24 in the front wall 14.

The lid 52 includes a main panel 56 and a peripheral rim 58 extending about the main panel 56 along side and rear edges of the lid. The peripheral rim 58 is substantially L-shaped in cross-section. As shown in FIG. 2, the lid 52 is adapted such that a horizontal portion of the peripheral rim 58 is supported on the horizontal ledge 42 of the cart body 12 when the lid 52 is in a closed position with respect to the body 12. The lid 52 is attached to the cart body 12 by a pair of hinges 60 secured to lid 52 adjacent a rear edge of the lid 52. Each of the lid hinges 60 is mounted to the cart body 12 in a hinge pocket 62 located on the rear wall 16 adjacent the end opening 22 at the top of the cart body 12. As seen by comparing FIGS. 2 and 3, the lid hinges 60 are adapted to pivot with respect to the cart body 12 during movement of the lid 52 between closed and opened positions of the lid 52.

The main panel 56 of the lid 52 is formed to define projections 64 on an outer surface of the lid 52. As should be understood, the forming of the main panel 56 to define projections 64 on the outer surface results in corresponding indentations on the inner surface of the panel (not shown). In a similar manner as described above for the wall formations on the cart body 12, the formations on the main panel 56 of lid 52 serves to strengthen the panel against transverse deflection.

The front door 54 of cart 50 is formed with a peripheral rim 66 that extends along opposite side edges and a lower edge of the front door 54. The door rim 66 is substantially L-shaped in cross section and is adapted for receipt against the ledge 46 and recessed surface 48 of the front wall 14 when the front door 54 is in the closed position shown in FIG. 2. The front door 54 includes formations defining projections 68 on an outer surface and corresponding indentations 70 on an inner surface to strengthen the front door 54.

Referring to FIG. 3, the cart 50 includes a hinge 72 connecting the front door 54 to the cart body 12 and providing for rotation of the door 54 between the closed and opened positions of the front door respectively shown in FIGS. 2 and 3. The hinge 72 includes a first plate 74 secured to the front door 54 adjacent a lower edge of the door 54 and a second plate 76 secured to the ledge 46 of the front wall 14 of cart body 12 along a lower edge of the notch opening 24.

The front wall 14 of the cart body 12 defines a recess 77 on the outer surface of the wall 14. As shown, the recess 77 is located below the notch opening 24 and is configured for receipt of the front door 45 when the door is rotated (e.g., dropped) with respect to the cart body 12 to the opened position shown in FIG. 3.

The front door 54 includes a latch member 78 depicted in the form of a loop (e.g., a U-bolt) located at an end of the door. As shown in FIG. 2, the latch member 78 is adapted for receipt by a slot opening 80 in the main panel 56 of the lid 52 when the lid 52 and front door 54 are both closed against the cart body 12. As should be understood, the receipt of the latch member 78 in the slot opening 80 of the lid 52 serves to hold the front door 54 in the closed position. The use of a loop configuration for the latch member 78 as depicted provides for engagement of a lock (e.g., a keyed or combination lock) with the latch member 78 for locking the cart 50 in the closed condition, thereby preventing access to the interior of the cart 50. As shown in FIG. 3, the latch member 58 is carried on flap extending from an inner surface of the front door 54 adjacent an upper edge of the front door.

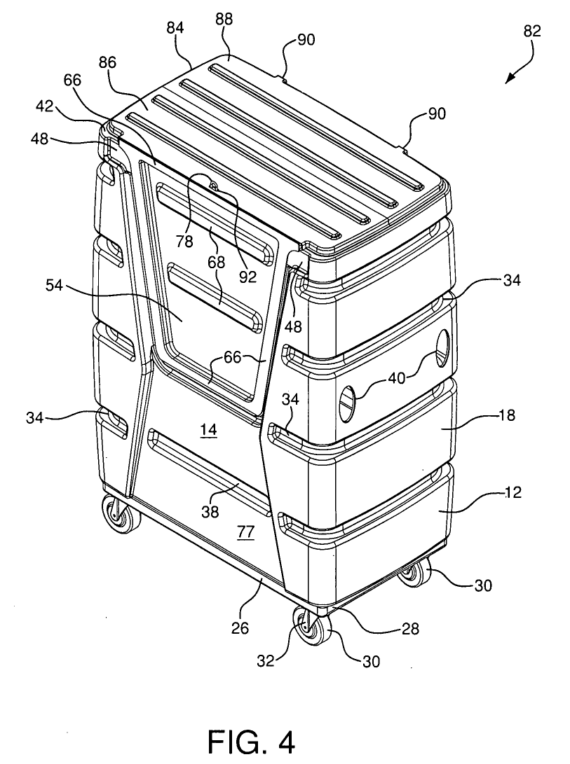

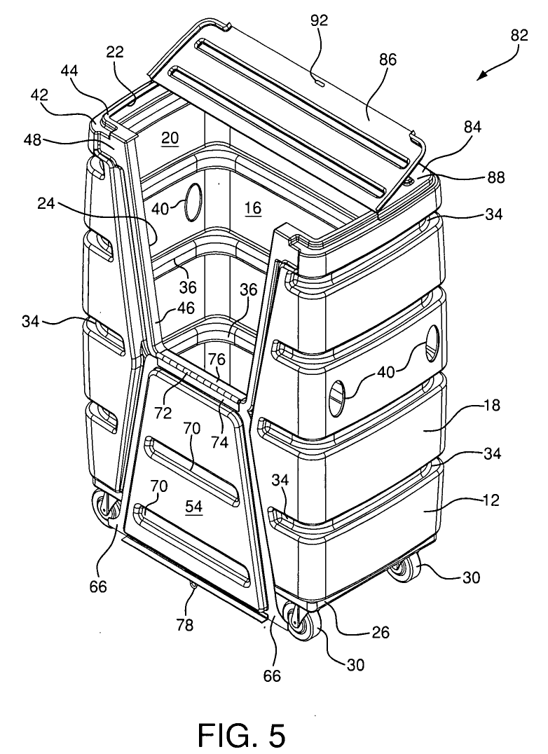

Referring to FIGS. 4 and 5, there is shown a cart 82 according to a third exemplary embodiment of the invention. Like carts 10 and 50, the cart 82 includes a body 12 having walls 14, 16, 18, 20 and a wheeled base 26. Like cart 50, the cart 82 includes a front door 54 for closing the notch opening 24 of front wall 14. The front door 54 is rotatably secured to the cart body 12 by a hinge 72 for rotation between closed and opened positions respectively shown in FIGS. 4 and 5.

The cart 82 includes a lid 84 for closing the end opening 22 of cart body 12. The lid 84 is a segmented lid including first and second segments 86, 88. As shown in FIGS. 4 and 5, the first and second segments 86, 88 are rotatably connected to each other for rotation of the first segment 86 with respect to the second segment 88 between closed and opened positions of the lid 84. The second segment 88 of the lid 84 includes mounts 90 received in the pockets 62 defined by the cart body 12 (e.g., snap attachment) for attaching the lid 84 to the cart body 12. The first segment 86 of the lid 84 defines a slot opening 92 arranged for receipt of the latch member 78 of front door 54 for securing door 54 in the closed position shown in FIG. 4.

Referring to FIG. 6, there is shown a cart 94 according to a fourth exemplary embodiment of the present invention. Like carts 10, 50, 82, cart 94 includes a body 12 having walls 14, 16, 18, 20 and a wheeled base 26. Like carts 50 and 82, cart 94 includes a front door 54 for closing the notch opening 24 of front wall 14. The front door 54 is rotatably secured to the cart body 12 by a hinge 72 for rotation between closed and opened positions.

The cart 94 includes a removable extension 96 received atop the cart body 12 for vertically extending the interior defined by the cart body 12. The extension 96 includes a rear wall 98 and side walls 100, 102 respectively located above the side walls 18, 20 and rear wall 16 of the cart body 12. The extension 96 includes front wall portions 104, 106 respectively located adjacent the side walls 100, 102.

Similar to the walls of cart body 12, the walls 98, 100, 102 of the removable extension 96 are formed to respectively define projections 108 and indentations 110 on inner and outer surfaces to strengthen the walls. To further reinforce the side walls 100, 102 against transverse deflection, the extension 96 includes a bar 112 extending between the front wall portions 104, 106 adjacent a top of the extension.

As shown, the removable extension 96 includes a lower end 114 formed for receipt on the horizontal ledge 42 of the cart body 12. Also, the front wall portions 104, 106 of extension 96 are adapted to contact the front wall 14 of cart body 12 adjacent the notch opening 24. As described above, the present invention is not limited to the depicted horizontal ledge 42 and lip 44 at the top of the cart body 12 and the depicted extension 96 having lower end 114 adapted for receipt by the cart body 12. Rather, the invention more broadly covers the combination of a cart body defining an interior and an extension received by the cart body for vertically extending the interior of the cart.

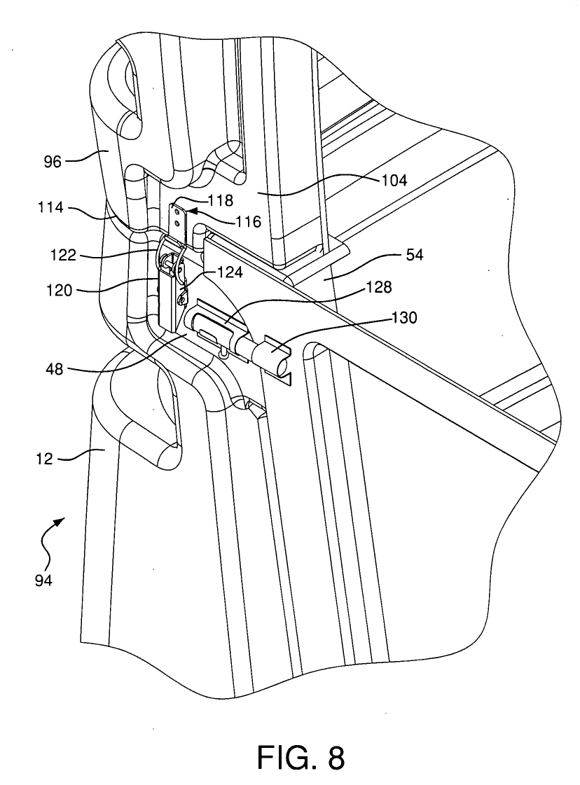

The cart 94 includes attachment mechanisms 116 at opposite sides of the cart 94 for releasably securing the removable extension 96 to the cart body 12. Referring to FIG. 8, there is shown an enlarged view of the front of the cart 94 showing one of the attachment mechanisms 116. The attachment mechanism 116 includes a first part 118 attached to the front wall portion 104 of extension 96 and a second part 120 attached to the recessed surface 48 of the front wall 14 of cart body 12. The second part 120 of the attachment mechanism 116 includes a loop 122 and an actuator 124 for moving the loop 122 with respect to the cart body 12. As shown, the loop 122 of the second part 120 is adapted to engage a hook 126 defined by the first part 118 so as to secure the first and second parts 118, 120 of the attachment mechanism 116 to each other.

Referring again to FIG. 8, the cart 94 is shown with the front door 54 in the closed position. As described above, the front door 54 for each of carts 50, 82 is retained in the closed position when the latch member 78 of the front door 54 is received by the lid 52 and lid 84, respectively. The cart 94, however, lacks a comparable feature to the lid 52 and lid 84 adapted for receiving the centrally-located latch member 78 of the door 54 when the door is rotated upwardly into the closed position. Instead, the cart 94 includes a door latch mechanism 128, mounted to the recessed surface 48 of the cart body front wall 14 adjacent the top of the cart body 12. As shown, a sliding bolt 130 of the door latch mechanism 128 is movable with respect to the cart body 12 into a latching position in which the sliding member overlies the peripheral lip 66 of the front door 54 along a side of the door so as to hold the door 54 in the closed position against the notch opening 24 of front wall 14.

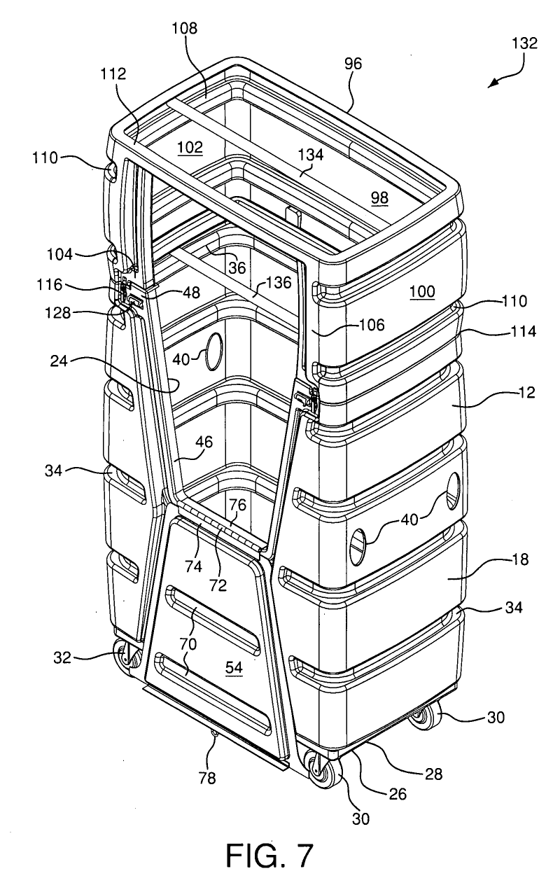

Referring to FIG. 7, there is shown a cart 132 according to a fifth exemplary embodiment of the invention. Like the above-described carts, cart 132 includes a body 12 having walls 14, 16, 18, 20 and a wheeled base 26. Cart 132 also includes a front door 54 for closing the notch opening 24 of front wall 14 and a removable extension 96 for vertically extending the interior of the cart.

The cart 132 includes an upper hanger bar 134 and a lower hanger bar 136 for supporting laundry in a suspended manner within the interior of the cart. As shown, the upper hanger bar 134 is received within the interior of the removable extension 96 such that the hanger bar 134 is supported at opposite ends by an uppermost one of the projections 108 on the inner surface of the extension. Similarly, the lower hanger bar 136 is received within the interior of the cart body 12 such that the hanger bar 136 is supported at opposite ends by an uppermost one of the projections 36 on the inner surface of the cart body 12.

Each of the carts 94, 132 shown in FIGS. 6 and 7 includes both an extension 96 received atop the body 12 for vertically extending the interior of the cart and a door 54 for closing the notch opening 24 in the front wall 14 of body 12. It should be understood, however, that the invention does not require both the extension 96 and the door 54. Therefore, the cart could include an extension received on a body having a notch opening or other access opening in the front wall without having a door to cover the opening.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A laundry cart adapted for multiple configurations comprising:
a body defining an interior and including a front wall, first and second side walls and a rear wall, the walls of the body defining an end opening at a top of the body,
the front wall defining a notch opening adjacent the top of the body, the notch opening communicating with the end opening,
the body adapted adjacent the top for alternatively receiving a lid for covering the end opening of the cart or a removable extension for vertically extending the interior of the cart,
the front wall adapted along an edge of the notch opening for receiving a door so as to cover the notch opening.

2. The laundry cart according to claim 1, wherein the body includes a horizontal ledge located at a periphery of the body at the top and a raised lip located inwardly of the horizontal ledge, the top ledge and lip adapted for alternatively receiving a lid or an extension, and wherein the front wall includes a ledge and a recessed surface extending along an edge of the notch opening, the ledge and recessed surface of the front wall adapted for receiving a door so as to cover the notch opening.

3. The laundry cart according to claim 2 further comprising:
a lid having a peripheral rim adapted for receipt by the top ledge and lip of the body such that the end opening of the body is covered by the lid, at least a portion of the lid rotatable with respect to the body for rotation between opened and closed positions; and
a door having a peripheral rim adapted for receipt by the ledge and recessed surface of the body front wall such that the door covers the notch opening,
the door and the lid adapted for engagement with each other so as to hold the door in the closed position.

4. The laundry cart according to claim 3, wherein the lid is segmented to include first and second segment and wherein the first segment is rotatable with respect to the second segment.

5. The laundry cart according to claim 2 further comprising:
a removable extension having a lower end adapted for receipt by the top ledge and lip of the body, the removable extension including a rear wall, first and second side walls and at least a partial front wall adapted to vertically extend the interior of the cart;
a door having a peripheral rim adapted for receipt by the ledge and recessed surface of the body front wall such that the door covers the notch opening, the door rotatably secured to the body for rotation between opened and closed positions; and
a door latch mechanism adapted to engage the front door so as to hold the door in the closed position.

6. The laundry cart according to claim 5 further comprising at least one attachment mechanism including first and second parts respectively secured to the removable extension and the body, the first and second parts of the attachment mechanism adapted to engage each other to provide releasable attachment between the removable extension and the body.

7. A laundry cart comprising:
a body defining an interior and including a front wall, first and second side walls and a rear wall, the walls of the body defining an end opening at a top of the body,
the front wall defining a notch opening adjacent the top of the body, the notch opening communicating with the end opening;
a lid adapted for receipt by the body adjacent the top of the body for covering the end opening, at least a portion of the lid moveable with respect to the body between opened and closed positions; and
a door adapted for receipt by the notch opening so as to cover the notch opening, the door moveable with respect to the body between opened and closed positions,
the door and lid adapted to engage each other so as to hold the door in the closed position.

8. The laundry cart according to claim 7, wherein the door includes a latch member located adjacent an end of the door and the lid includes a slot opening, the slot opening of the lid receiving the latch member of the door.

9. The laundry cart according to claim 7 further including a hinge rotatably securing the door to the body for rotation of the door between the opened and closed positions for the door.

10. The laundry cart according to claim 7 further including at least one hinge member rotatably securing to the lid to the body for rotation of the lid between the opened and closed positions for the lid.

11. The laundry cart according to claim 7 wherein the lid is segmented to include first and second segments, the second segment mounted to the body, the first segment rotatable with respect to the second segment for rotation of the first segment between opened and closed positions.

12. The laundry cart according to claim 7, wherein each wall of the body is formed so as to define indentations in an outer surface and projections in an inner surface for strengthening the wall against transverse deflection.

13. The laundry cart according to claim 7, wherein the body includes a horizontal ledge located at a periphery of the body at the top of the body and a raised lip located inwardly of the horizontal ledge and wherein the lid includes a peripheral rim adapted for receipt by the ledge and raised lip at the top of the body.

14. The laundry cart according to claim 7, wherein the body includes a ledge and a recessed surface extending along an edge of the notch opening and wherein the door includes a peripheral rim adapted for receipt by the ledge and recessed surface of the body.

15. A laundry cart comprising:
a body defining an interior and including a front wall, first and second side walls and a rear wall, the walls of the body defining an end opening at a top of the body; and
a removable extension including a rear wall, first and second side walls and at least a partial front wall, the removable extension including a lower end received by the top of the body so as to vertically extend the interior defined by the body.

16. The laundry cart according to claim 15 further comprising at least one attachment mechanism including first and second parts respectively secured to the removable extension and the body, the first and second parts of the attachment mechanism adapted to engage each other to provide releasable attachment between the removable extension and the body.

17. The laundry cart according to claim 15, wherein the front wall of the body defines a notch opening adjacent the top of the body, the cart further comprising:
a door adapted for receipt in the notch opening of the body so as to cover the notch opening, the door rotatably secured to the body for rotation between opened and closed positions; and
a door latch mechanism including a sliding member, the sliding member adapted for movement to a latched position in which the sliding member overlies an edge portion of the door so as to hold the door in the closed position.

18. The laundry cart according to claim 15 further comprising at least one hanger bar supported by the side walls of either one of the removable extension and the body for suspending laundry within the interior of the cart.

19. The laundry cart according to claim 17, wherein the body includes a peripheral horizontal ledge at the top of the body and a raised lip adjacent the ledge, the lower end of the extension adapted for receipt by the top ledge and lip of the body, and wherein the front wall of the body includes a ledge and a recessed surface extending along an edge of the notch opening, the door including a periphery adapted for receipt by the ledge and recessed surface of the body front wall.
